(19) United States
(12) Patent Application Publication
(10) Pub. No.: US 2006/0159170 A1
(43) Pub. Date: Jul. 20, 2006

(54) Method and system for hierarchical search with cache

(76) Inventor: Ren-Wei Chiang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/334,503

(22) Filed: Jan. 19, 2006

Related U.S. Application Data
(60) Provisional application No. 60/644,577, filed on Jan. 19, 2005.

(51) Int. Cl. H04N 7/12; H04N 11/04; H04B 1/66; H04N 11/02

(52) U.S. Cl. 375/240.12; 375/240.24

(57) ABSTRACT

A method and system for hierarchical search with a cache are disclosed. After a level 1 search area and a current macro block are loaded from a memory system, the cache stores a portion of the level 1 search area. Level 1 motion can be estimated by finding a best matched macro block, which is most matched with the current macro block, in the level 1 search area. Then a level 0 search area can be loaded according to the level 1 motion. The level 0 search area is loaded when the cache contains it, otherwise the level 0 search area is loaded from the memory system.

### CROSS REFERENCE TO RELATED APPLICATIONS

This application claims the benefit of U.S. Provisional Application No. 60/644577, filed on Jan. 19, 2005, which is herein incorporated by reference for all intents and purposes.

### BACKGROUND OF THE INVENTION

1. Field of the Invention

The present invention generally relates to a hierarchical search method and system, and more particularly to a hierarchical search method and system with cache.

2. Description of the Prior Art

Hierarchical search (Multi-Level Search) is a Motion Estimation (ME) technology widely used in large search area (SA) motion estimation. But this algorithm needs some additional memory bandwidth to provide search area in different level.

Motion estimation is a procedure to find a search position in search area with best matching macro block. There are two main matching criteria: one is sum absolute difference (SAD), the other is mean square error (MSE). In general, macro block is a basic unit, which is an n by n pixel array when encoding a series of moving pictures, wherein n can be 16 or other number. Search area is an (n+21) by (n+2m) pixel array based on a macro block, wherein 1 and m can be 4 or other numbers separately. The macro block is located on the center of the search area. Each pixel in search area is said a search position.

Full search is the simplest and the most intuitional algorithm, but the computing power is very large and time consuming for large search area. Hierarchical search is focus on the drawback of full search. The basic concept of hierarchical search is “First roughly search in a small picture, then detail search in a big picture”. Usually, hierarchical search is a 2-level search, first performing a level 1 search to roughly search a level 1 motion in a level 1 search area. Then, performing a level 0 search to fully search a level 0 motion in a level 0 search area. Wherein the level 1 search area for level 1 search is a rough search area of the level 0 search area for level 0 search. Each search position of level 1 search area is the average of a group of pixels in level 0 search area.

Referring to FIG. 1A, the level 0 search area can be identified by a plurality of groups, and each group contains a plurality of pixels. In this example, the number of pixels in a group is 4. Then the ¼ average reduced sample of level 0 search area (16 by 16 pixel arrays) is the level 1 search area. For example, the level 1 search area with 8 by 8 pixel array is the ¼ average of the level 0 search area with 16 by 16 pixel array. Because there are less search positions in level 1 search area, we can speed up search and reduce large amount of computing power for large search area. The transformation of the reduced sample can be a linear transformation. That is, a pixel array can become a samples array named a reduced sample by the linear transformation. Each sample in the reduced sample can be the average, weighted value, or other transformation result according to a plurality of pixels.

Thus, a hierarchical search has a level 1 motion estimation for estimating a level 1 motion and a level 0 motion estimation for estimating a level 0 motion. The level 1 motion is estimated by finding a reduced sample of a best matched macro block of a plurality of macro blocks, which are correspondent to a plurality of search positions within said level 1 search area, respectively. The best matched macro block is found by comparing the differences. Each of the differences is between one of the reduced samples, correspondent to one of the macro blocks, individually, and a reduced sample correspondent to the current macro block respectively. The minimum difference of all differences is between the reduced sample of said best matched macro block and the reduced sample of the current macro block. Similarly, the level 0 motion is estimated by finding a best matched macro block of a plurality of macro blocks, which are correspondent to a plurality of search positions within the level 0 search area, respectively. The best matched macro block is found by comparing the differences. Each of the difference is between one of the macro blocks and the current macro block individually, wherein the minimum difference is between the best matched macro block and the current macro block. The differences are computed by the following criteria: SAD, MSE, or the like.

Referring to FIG. 1B, the hierarchical search method in the prior art is illustrated. First, loading a level 1 search area in the step 110. Then roughly searching a level 1 motion in the level 1 search area in the step 120. Moreover, loading a level 0 search area from an external memory in the step 130. Finally, performing the step 140, fully searching a level 0 motion in the level 0 search area. When the level 1 motion is found in the step 120, the level 0 search area corresponding to the level 1 motion is loaded for the level 0 motion estimation in the step 130. The level 0 search area is smaller than the level 1 search area.

Referring to FIG. 1C, the memory accesses of level 1 search area and level 0 search area are via memory interface 12 for level 1 motion estimation 142 and level 0 motion estimation 144 separately. The level 0 search area is loaded according to the level 1 motion. Because the level 1 search roughly compares the reduced sample, thus the hierarchical search is faster than the full search. But the hierarchical search method in prior art still costs a lot of bandwidth of memory access. The bandwidth of memory access is one of the bottlenecks in encoding. For example, in the prior art, the drawback of the hierarchical search is the extra bandwidth for loading level 0 search area. For example, a real-time video encoder for supporting DVD PAL 720×576×25 Hz needs to handle 45×36×25=40500 macro blocks per second. One through four level 0 search areas need to be loaded for each level 0 motion estimation. The level 0 search area can be ±4×±4. That is, the search area may be a 24×24 (4+16+4=24) pixel array if the macro block is a 16×16 pixel array. If the memory interface 12 is 8 bytes, then 32×24 (32×24=768) pixel array needs to be loaded for selecting a 24×24 pixel array. Accordingly, the bandwidth of the level 0 search will be 124.42M macro blocks/sec (40500×4×32×24=12441600). Although the range of the search area is small (±4×±4), the demanded memory bandwidth is so large.

### SUMMARY OF THE INVENTION

Because memory bandwidth requirement of motion estimation is relatively larger and critical in video encoder, the present invention proposes an improved methodology to make use of the benefit of hierarchical search and get reasonable memory bandwidth.

According to the preferred embodiment of the present invention, a system for hierarchical search with cache includes a level 1 motion estimating module, a cache and a level 0 motion estimating module. Level 1 motion estimating module estimates a level 1 motion in a level 1 search area according to a current macro block. Cache is used to store a portion of said level 1 search area. Level 0 motion estimating module estimates a level 0 motion in a level 0 search area according to the current macro block, wherein the level 0 search area is loaded according to the level 1 motion and the level 0 search area is loaded from the cache if the cache contains the level 0 search area.

According to another preferred embodiment of the present invention, a method for hierarchical search with cache includes the following steps. First, loading a level 1 search area and a current macro block from a memory system, wherein a portion of the level 1 search area is stored into a cache. Then, estimating a level 1 motion by finding a best matched macro block, which is most matched with the current macro block in the level 1 search area. Next, loading a level 0 search area according to the level 1 motion, wherein the level 0 search area is loaded from the cache if the level 0 search area is within the cache, otherwise the level 0 search area is loaded from the memory system;. Finally, estimating a level 0 motion by finding a best matched macro block which is most matched with the current macro block in the level 0 search area.

Therefore, in accordance with the previous summary, objects, features and advantages of the present disclosure will become apparent to one skilled in the art from the subsequent description and the appended claims taken in conjunction with the accompanying drawings.

### BREIF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1A to FIG. 1C are the diagrams illustrating the hierarchical search method and system in the prior art; and

FIG. 2A is a diagram illustrating a method for hierarchical search with cache according to one embodiment of the present invention.

FIG. 2B to FIG. 2C are the diagrams illustrating a system for the hierarchical search with cache according to another embodiment of the present invention.

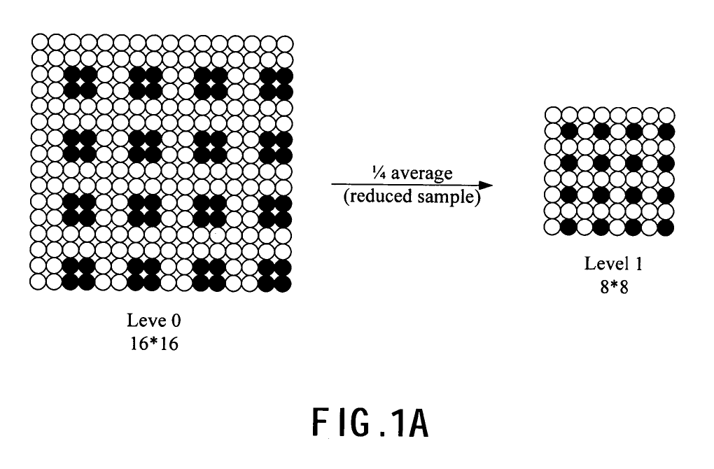

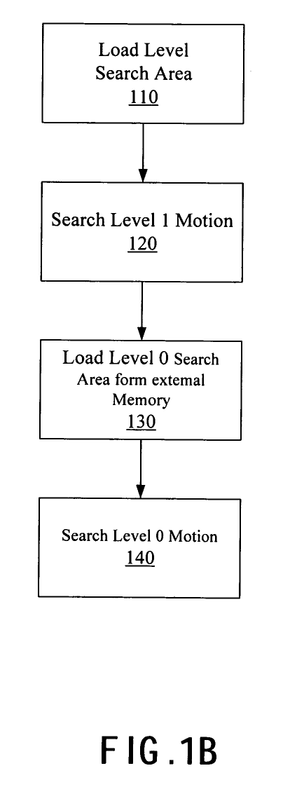

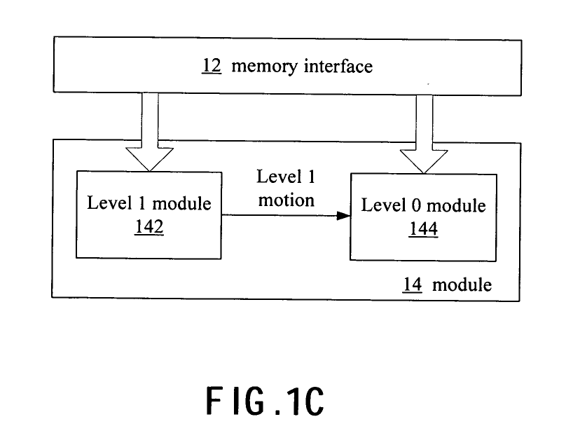

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

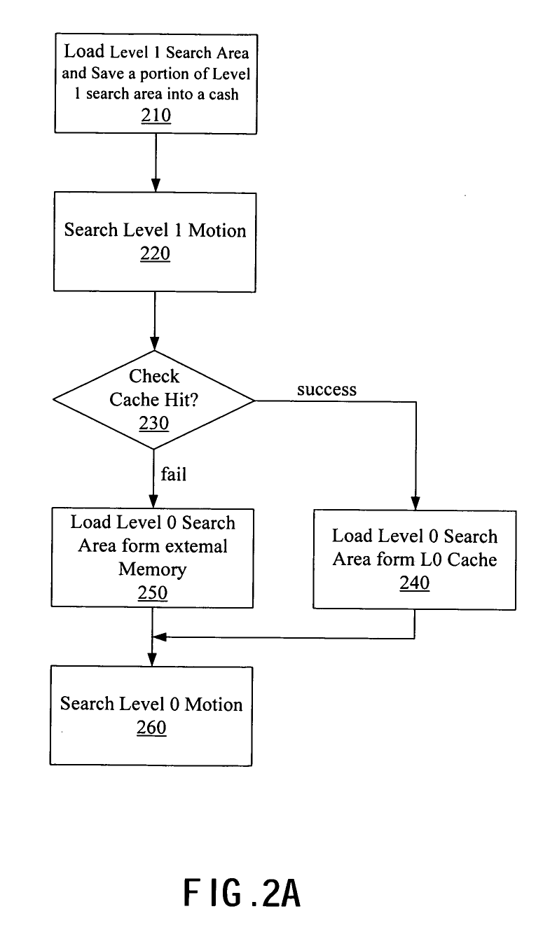

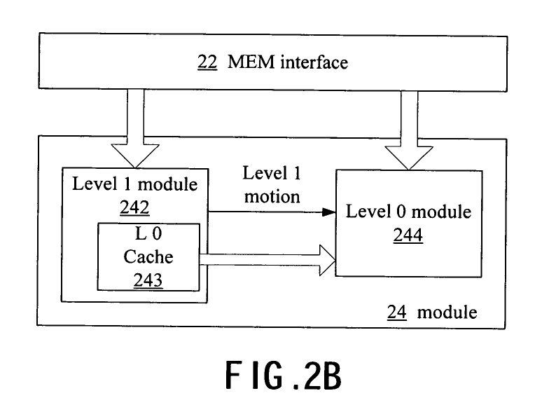

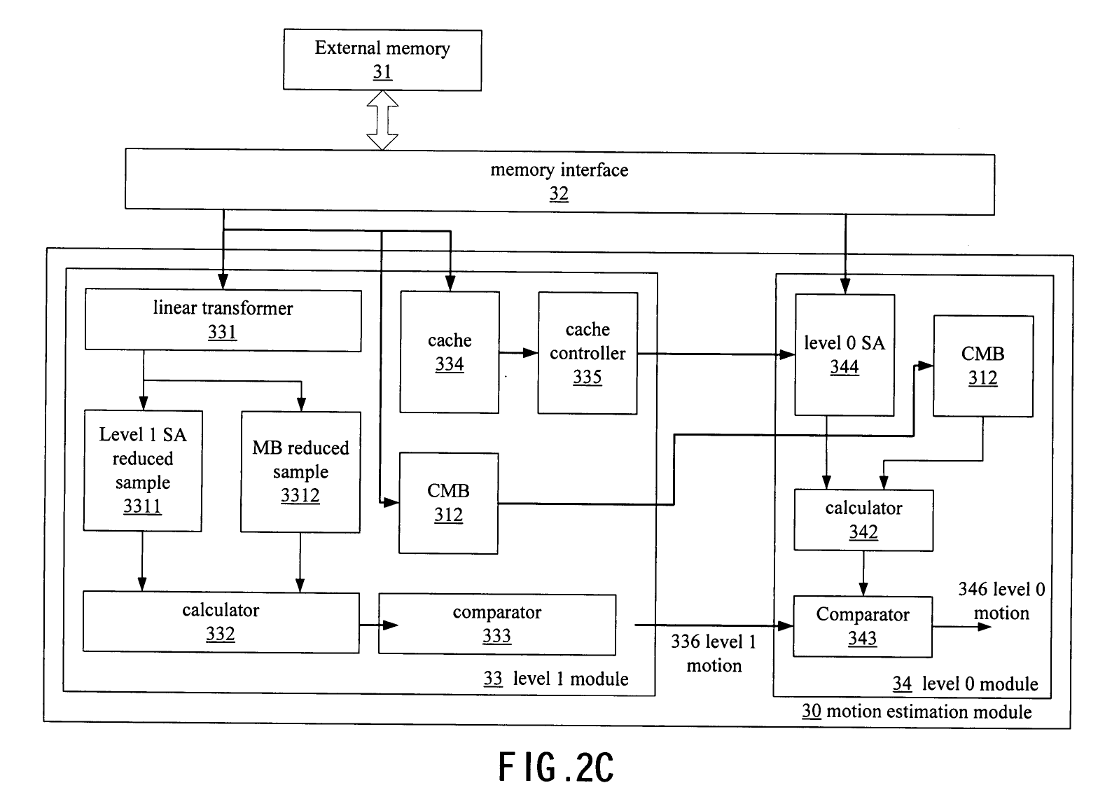

For reducing the bandwidth of memory access, one embodiment of the present invention is a hierarchical search method with cache, referring to FIG. 2A. Whenever a macro block which is named current macro block is searched, first in the step 210, loading a level 1 search area and stores the level 1 search area in a level 1 memory. A portion of the level 1 search area is stored in a level 0 cache, wherein the portion has the higher probability to include the level 0 search area. The memory can be random access memory, buffer, or other storage means. Then in the step 220, searching a level 1 motion in the level 1 search area. Wherein the level 1 search area and the current macro block will be used to generate a reduced sample of the level 1 search area and a reduced sample of the current macro block separately. The level 1 motion is estimated by the level 1 search in the reduced sample of the level 1 search area according to the reduced sample of the current macro block. Whenever a level 1 motion is found, in the step 230, checking the cache hit in the level 0 cache. According to the level 1 motion, the level 0 search area can be determined. If the level 0 search area is within the level 0 cache, the cache hit successes. Otherwise, the cache hit fails. If the cache hit successes, in the step 240, loading the level 0 search area from level 0 cache. If the cache hit fails, in the step 250, loading the level 0 search area from an external memory. After the level 0 search area is loaded, in the step 260, estimating a level 0 motion in the level 0 search area.

Referring to FIG. 2B, a level 0 cache 243 is added in the level 1 motion estimation 242. The cache 243 is provided for storing a portion of the level 1 search area which has the higher probability to include the level 0 search area. If the level 0 search area exists within the level 0 cache 243, the level 0 search area can be loaded from the level 0 cache 243 for level 0 motion estimation 244 and then no external memory access is needed. Otherwise, level 0 search area should be loaded via the memory interface 12 for level 0 motion estimation. Accordingly, the higher the hit ratio of the cache is, the more memory bandwidth is reduced.

Accordingly, another embodiment of the present invention is a system for hierarchical search with cache, including an external memory 31, a memory interface 32, a level 1 motion estimating module 33 and a level 0 motion estimating module 34, Referring to FIG. 2C. The external memory 31 and the memory interface 32 can be included in a memory system, and the level 1 motion estimating module 33 and the level 0 motion estimating module 34 can be included in a motion estimation module 30.

The external memory 31 stores a series of frames or fields. Each frame or field contains a plurality of macro blocks. The motion estimation of each macro block is performed by the hierarchical search method with cache. A macro block for motion estimation is called a current macro block 312 (CMB). According to the current macro block 312, the level 1 search area can be determined such as the forgoing step 210, the current macro block 312 and the level 1 search area are loaded into the level 1 motion estimating module 33 by the memory interface 32.

The level 1 motion estimating module 33 includes a linear transformer 331, a calculator 332, and a comparator 333. The level 1 motion estimating module 33 can be used to perform the forgoing step 220. The linear transformer 331 is used to generate a reduced sample of the level 1 search area 3311 and a reduced sample of current macro block 3312 according to the level 1 search area and the current macro block 312 separately. The level 1 search area 3311 contains a plurality of search positions that each of the search positions is correspondent to a macro block, correspondent to a reduced sample within the reduced sample of the level 1 search area 3311. That is, a reduced sample correspondent to a macro block is also correspondent to a search position that is correspondent to the same macro block. Then calculator 332 calculates a plurality of differences that each of the differences is between a reduced sample correspondent to one of the macro blocks and a reduced sample correspondent to the current macro block 3312. Thereafter, the comparator 333 chooses a minimum difference that is between the reduced sample correspondent to a best matched macro block and the reduced sample correspondent to the current macro block 3312 to estimate a level 1 motion 336. Accordingly, the level 1 search of the level 1 motion estimation can be made.

Besides, the level 1 motion estimating module 33 includes a cache 334 for caching a portion of level 1 search area, wherein the portion has the higher probability to include the level 0 search area. When the level 1 motion 336 is found, the cache hit for the level 0 search area is performed according to step 230. If the cache hit is successes, the level 0 motion estimating module 34 loads level 0 search area 344 from the cache 334 according to step 240. Otherwise, the level 0 motion estimating module 34 loads level 0 search area 344 from the external memory 31 via the memory interface 32 according to step 250. Besides, the current macro block 312 can be loaded from the level 1 motion estimating module 33 to level 0 motion estimating module 34. The cache 334 can be controlled by a cache controller 335.

The level 0 motion estimating module 34 includes a calculator 342 and a comparator 343 for level 0 motion estimation according to step 260. The level 0 search area 344 includes a plurality of search positions, wherein each search position identifies a macro block. The calculator 342 calculates the differences between each macro block and the current macro block 312. Thereafter, the comparator 343 chooses a best matched macro block that the difference between the best matched macro block and the current macro block 312 is minimum to generate a level 0 motion 346. Accordingly, the level 0 search of the level 0 motion estimation can be made. The calculator 342 and the comparator 343 can be included in or replaced by a level 0 search means. Similarly, the calculator 332 and the comparator 333 can be included in or replaced by a level 1 search means.

Besides, the current macro block 312 can be loaded into a storage means in both of the level 1 motion estimating module 33 and the level 0 motion estimating module 34, or loaded in a storage means shared for both of the level 1 motion estimating module 33 and the level 0 motion estimating module 34. With the storage means, the loading of the current macro block 312 for estimating level 0 motion 346 from the external memory 31 is not needed.

Moreover, the search area and current macro block can be represented by the luminance and the chrominance of the pixel array, or only the luminance of the pixel array. The luminance is preferred in the present invention. The search area and current macro block can also be selected from the RGB value (red, green, and blue) of the pixel array, or the like. The present invention does not limit the type of attributes for presenting the search area and current macro block.

The motion has the characteristic of spatial locality. For example, most norms of motions in motion estimation are less than 50. It means that most of the best matched macro blocks are near the position of the corresponding current macro block 312. The cache hit rate can be raised to very high if the cache 334 stores a pixel array just including the range of the neighborhood of the corresponding current macro block 312. In other words, even if cache size is small, a good amount of bandwidth still can be saved. According to one embodiment of the present invention, a cache is provided for saving a portion of the level 1 search area which has the higher probability to include the level 0 search area. Because the level 0 search are has the spatial locality, the cache can have a good hit ratio. For example, about 90% motion is below 50, thus an 8 KB (±24×±24=(24+16+24)×(24+16+24)×2 =8192 bytes) level 0 cache could has about 70% through 80% hit ratio. With the cache, a lot of memory bandwidth for loading level 0 search area can be saved by a small hardware cost.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A system for hierarchical search with cache, comprising:
a level 1 motion estimating module for estimating a level 1 motion in a level 1 search area according to a current macro block;
a cache for storing a portion of said level 1 search area; and
a level 0 motion estimating module for estimating a level 0 motion in a level 0 search area according to said current macro block, wherein said level 0 search area is loaded according to said level 1 motion and said level 0 search area is loaded from said cache if said cache contains said level 0 search area.

2. A system of claim 1, further comprising a memory system for providing said level 1 search area and said current macro block.

3. A system of claim 2, wherein said level 0 search area is loaded from said memory system if said cache does not contains said level 0 search area.

4. A system of claim 1, said level 0 motion is estimated by finding a best matched macro block of a plurality of macro blocks, which are correspondent to a plurality of search positions within said level 0 search area, respectively.

5. A system of claim 4, wherein said best matched macro block is found by comparing the differences that each of said differences is between one of said macro blocks and said current macro block individually, wherein the minimum difference is between said best matched macro block and said current macro block.

6. A system of claim 1, wherein said level 1 motion is estimated by finding a reduced sample correspondent to a best matched macro block of a plurality of macro blocks, wherein each reduced sample correspondent to one of said macro blocks is correspondent to one of a plurality of search positions within said level 1 search area, respectively.

7. A system of claim 6, wherein said best matched macro block is found by comparing the differences that each of said differences is between one of said reduced samples correspondent to one of said macro blocks and a reduced sample correspondent to said current macro block individually, wherein the minimum difference is between said reduced sample of said best matched macro block and said reduced sample of said current macro block.

8. A system of claim 7, wherein both of said level 1 search area and said current macro block are pixel arrays with a plurality of pixels, and said reduced sample is a sample array with a plurality of samples, wherein each sample is generated according to a group of said pixels separately.

9. A system of claim 8, wherein said sample is the average of said group of said pixels.

10. A system of claim 8, wherein each of said pixels is represented by a set selected from the following group: chrominance, luminance, red color value, green color value, and blue color value.

11. A method for hierarchical search with cache, comprising:
loading a level 1 search area and a current macro block from a memory system, wherein a portion of said level 1 search area is saved into a cache;
estimating a level 1 motion by finding a best matched macro block, which is most matched with said current macro block in said level 1 search area;
loading a level 0 search area according to said level 1 motion, wherein said level 0 search area is loaded from said cache if said level 0 search area is within said cache, otherwise said level 0 search area is loaded from said memory system; and
estimating a level 0 motion by finding a best matched macro block which is most matched with said current macro block in said level 0 search area.

12. A system of claim 11, said level 0 motion is estimated by finding a best matched macro block of a plurality of macro blocks, which are correspondent to a plurality of search positions within said level 0 search area, respectively.

13. A system of claim 12, wherein said best matched macro block is found by comparing the differences that each of said differences is between one of said macro blocks and said current macro block individually, wherein the minimum difference is between said best matched macro block and said current macro block.

14. A system of claim 11, wherein said level 1 motion is estimated by finding a reduced sample correspondent to a best matched macro block of a plurality of macro blocks, wherein each reduced sample correspondent to one of said macro blocks is correspondent to one of a plurality of search positions within said level 1 search area, respectively.

15. A system of claim 14, wherein said best matched macro block is found by comparing the differences that each of said differences is between one of said reduced samples correspondent to one of said macro blocks and a reduced sample correspondent to said current macro block individually, wherein the minimum difference is between said reduced sample of said best matched macro block and said reduced sample of said current macro block.

16. A system of claim 15, wherein both of said level 1 search area and said current macro block are pixel arrays with a plurality of pixels, and said reduced sample is a sample array with a plurality of samples, wherein each sample is generated according to a group of said pixels separately.

17. A system of claim 16, wherein said sample is the average of said group of said pixels.

18. A system of claim 16, wherein each of said pixels is represented by a set selected from the following group: chrominance, luminance, red color value, green color value, and blue color value.
